(19) United States
(12) Patent Application Publication
(10) Pub. No.: US 2024/0364164 A1
(43) Pub. Date: Oct. 31, 2024

(54) STATOR DEVICE FOR AN ELECTRIC MACHINE, TOOL, METHOD FOR PRODUCING A STATOR DEVICE, ELECTRIC MACHINE AND VEHICLE

(71) Applicant: VALEO SIEMENS EAUTOMOTIVE GERMANY GMBH, Erlangen (DE)

(72) Inventors: Robin BUESCH, Bad Neustadt a.d.Saale (DE); Fabian SEUFERT, Bad Neustadt a.d.Saale (DE)

(73) Assignee: Valeo eAutomotive Germany GmbH, Erlangen (DE)

(21) Appl. No.: 18/291,372

(22) PCT Filed: Jul. 25, 2022
(86) PCT No.: PCT/EP2022/070784

§ 371 Date: Jan. 23, 2024

(30) Foreign Application Priority Data
Jul. 27, 2021 (DE) 10 2021 208 054.5

(51) Int. Cl. H02K 3/24; B60K 6/26; H02K 9/197; H02K 15/12

(52) U.S. Cl. CPC H02K 3/24; H02K 9/197; H02K 15/12; B60K 6/26; B60L 2220/50

(57) ABSTRACT

A stator device for an electric machine includes a stator core which has an axial end face and a plurality of hollow guides each of which passes axially through the stator core, has an outer portion projecting out of the stator core at the end face and is designed to guide a temperature control fluid in their interior. A compensating body forms a plurality of fluid conduits which are separated from one another, each adjoining the outer portion of one of the hollow guides in order to convey the temperature control fluid between an opening of the fluid conduit and the interior of the hollow guide.

The present invention relates to a stator device for an electric machine. In addition, the invention relates to a tool for forming a compensation body of a stator device, a method for producing a stator device, an electric machine and a vehicle.

DE 10 2017 204 472 A1 discloses a stator for an electric machine, comprising a stator winding and a stator yoke with a plurality of grooves. The stator winding has a plurality of interconnected conductor segments, each with an axially inner inner section and two axially outer outer sections, the inner sections being embedded in the grooves of the stator yoke. In a subset of the conductor segments, the inner sections are designed as hollow conductors, with the result that interior spaces of the conductors form channels for the flow of coolant in the axial direction. A casting compound is applied to an axial end region of the stator.

When producing a stator device with a plurality of hollow conductors, each of which passes axially through the stator core, has an outer section protruding from an axial end side of a stator core and is designed to conduct a temperature control fluid in its interior, manufacturing tolerances can occur on the outer sections, which make further manufacturing steps of the stator device difficult. These manufacturing tolerances concern, for example, respective lengths of the outer sections, i.e. how far a respective outer section protrudes from the stator core, or respective angles that the outer sections enclose with the end side of the stator core. This can, for example, make it difficult to connect suitable inlet and outlet lines for the temperature control fluid.

The invention is based on the object of providing a production-friendly option for temperature control of a stator device with hollow conductors.

This object is achieved according to the invention by a stator device for an electric machine, comprising a stator core which has an axial end side; a plurality of hollow conductors, each of which passes axially through the stator core, has an outer section protruding from the stator core on the end side and is designed to conduct a temperature control fluid in its interior; and a compensation body which forms a plurality of separated fluid channels, each of which connects to the outer section of one of the hollow conductors in order to guide the temperature control fluid between an opening of the fluid channel and the interior of the hollow conductor.

The stator device according to the invention for an electric machine comprises a stator core. The stator core has an axial end side. The stator device further comprises a plurality of hollow conductors. The hollow conductors each pass through the stator core axially. The hollow conductors each have an outer section. The outer section protrudes from the stator core on the end side. The hollow conductors are each designed to conduct a temperature control fluid in their interior. The stator device further comprises a compensation body. The compensation body forms a plurality of fluid channels. The fluid channels are separated from each other. The fluid channels each connect to the outer section of one of the hollow conductors in order to guide the temperature control fluid between an opening of the fluid channel and the interior of the hollow conductor.

The invention is based on the idea of providing an expansion of the hollow conductors by means of the fluid channels formed by the compensation body. The compensation body can compensate for manufacturing tolerances with regard to respective lengths of the outer sections and/or respective angles between the outer sections and the end side of the stator core. As a result, for example, a reference surface can be formed by the compensation body in the axial extension of the hollow conductors, which makes it easier to connect the hollow conductors. A production-friendly stator device is thus advantageously provided.

The stator core is preferably formed from a multiplicity of axially layered and/or mutually electrically insulated individual laminations. The stator core can be considered or referred to in particular as a stator laminated core. The stator core in particular has a multiplicity of grooves arranged one after the other in the circumferential direction, each of which passes through the stator core in the axial direction.

The hollow conductors in particular form a current path for a stator winding of the stator device. On the end side, the outer sections of the hollow conductors can be connected to one another in pairs in an electrically conductive and mechanical manner, in particular in a materially bonded manner. The manufacturing tolerances can occur in particular by way of a materially bonded connection, in particular welding, of the outer sections.

The hollow conductors can be of tube-like design. The hollow conductors preferably have a circular, oval, rectangular or rounded rectangular outer profile and/or inner profile. The hollow conductors are preferably formed from an electrically conductive metal, in particular copper or a copper alloy. The temperature control fluid is preferably a temperature control liquid, in particular oil or water. The stator device is in particular designed to cool the stator by means of the temperature control fluid. The temperature control fluid can then also be understood or referred to as a cooling fluid.

The hollow conductors preferably have an inner section which is arranged in the grooves within the stator core and to which the outer section adjoins on the end side. The hollow conductors can be connected to one another in pairs in a fluid-conducting manner by a connecting section on another end side of the stator core opposite the end side. Two hollow conductors connected by the connecting section can thus form a U or V shape, with the result that the temperature control fluid can flow from the end side to the other end side through one of the hollow conductors connected in pairs, at the other end side can flow through the connecting section, and can flow from the other end side to the first end side through the other one of the hollow conductors connected in pairs.

The compensation body is preferably formed from a hardened casting compound. The compensation body is preferably formed in one piece. The compensation body preferably extends annularly in the circumferential direction along the end side of the stator core.

It can advantageously be provided that the compensation body is molded onto the stator core. In other words, the compensation body directly touches the stator core on the end side. Firstly, this enables simple production of the compensation body, in particular by way of a casting process. Secondly, the compensation body can be mechanically fixed by the outer sections of the hollow conductors and supported on the end side against undesired axial movements.

Moreover, it can be provided that the compensation body adjoins the stator core flush radially on the inside and/or radially on the outside of the stator core. The compensation body can thus form an axial continuation of the stator core.

In one preferred development, it can be provided that the compensation body extends in the axial direction away from the stator core beyond a free end of the outer section of a respective hollow conductor. This allows the compensation body to form the desired extension in the axial direction pointing away from the stator core.

The openings of the fluid channels are particularly preferably located at the same axial position. An end side of the compensation body opposite the stator core, which forms the opening of a respective fluid channel, can thus form the reference surface, which is perpendicular to the axial direction. However, the reference surface can alternatively also run obliquely.

At its axial end facing away from the stator core, the compensation body can taper radially on the outside in a direction pointing away from the stator core. Alternatively or additionally, the compensation body can taper on its radially inner surface in the direction pointing toward the stator core. The taper enables a tool to be easily removed from the mold, particularly with regard to a casting process for producing the compensation body.

In one preferred embodiment, the stator device according to the invention further comprises a fluid chamber into which a respective opening of at least part of the fluid channels opens and which connects the openings of the fluid channels to one another in a fluid-conducting manner. The fluid chamber can enable the temperature control fluid to be supplied and/or removed. The compensation body allows the fluid chamber to be positioned within the stator device independently of the manufacturing tolerances of the hollow conductors. With regard to the second fluid chamber described further below, this fluid chamber can also be referred to as the first fluid chamber.

It is further preferred that the stator device according to the invention further comprises a housing part. In particular, the stator device has a housing which comprises the housing part. The housing part in particular forms a front-side termination of the housing of the stator device. The housing part can be a bearing shield, preferably an A-end shield (drive end shield). The housing part can also be referred to as the first housing part with regard to the second housing part described further below.

In one preferred embodiment, the housing part forms an axial boundary, a radially inner boundary and an axial outer boundary of the fluid chamber and rests on the compensation body. The fluid chamber can thus advantageously be designed as an integral part of the housing part, with the result that the supply or removal of the temperature control fluid for the hollow conductors can take place via the housing part and the compensation body.

The stator device preferably comprises a second fluid chamber, into which a respective opening of a second part of the fluid channels opens, which connects the openings of the second part of the fluid channels to one another in a fluid-conducting manner and which is separated from the first fluid chamber on the end side in an at least liquid-tight, in particular fluid-tight, manner. One of the fluid chambers, preferably the first fluid chamber, can thus form a feed line for the temperature control fluid. The other fluid chamber, preferably the second fluid chamber, can form a return line for the temperature control fluid. If the fluid chamber forming the feed line is the inner fluid chamber, cooler temperatures can be made possible on the inside, which advantageously allows a rotor arranged within the stator core and, if necessary, permanent magnets arranged in it to be cooled more efficiently.

The housing part can further form an axial boundary, a radially inner boundary and a radially outer boundary of the second fluid chamber. The radial boundaries of the first fluid chamber and/or the second fluid chamber can be formed by projections of the housing part that point axially toward the stator core. The projections are in particular formed in one piece with, and/or with the same material as, the housing part. Preferably, the first part of the fluid channels is arranged radially further inward than the second part of the fluid channels. In particular, a respective fluid channel is arranged in one of an even number N of radial positions. The first part of the fluid channels can be formed at the N/2 radially inner radial positions and the second part of the fluid channels can be formed at the N/2 radially outer radial positions. N can be four, six, eight or ten. The radial positions preferably correspond to a plurality of radial laminations in which the hollow conductors, in particular their inner sections, are arranged within the grooves of the stator core.

Sealing means are preferably provided between the housing part, in particular the projections of the housing part, and the compensation body, which seal the fluid chamber or the fluid chambers. The sealing means are, for example, O-rings.

The stator device can further comprise a second housing part that radially surrounds the stator core. In this regard, the second housing part can be viewed as a housing jacket. The first housing part can be attached to the second housing part, for example screwed. The compensation body is particularly preferably integrally formed on the second housing part. The housing can comprise the second housing part. When the first housing part and the second housing part are fastened to one another, the compensation body serves in particular to compensate for the manufacturing tolerances of the hollow conductors with regard to the position of the fluid chamber or fluid chambers predetermined by the fastening of the first and second housing parts. By fastening the first and second housing parts, the sealing means can be pressed.

The stator device can further comprise a heat exchanger for the temperature control fluid, via which a closed cooling circuit, which comprises the fluid channel or the fluid channels and the hollow conductors, is formed.

The object on which the invention is based is further achieved by a tool for forming a compensation body of a stator device, which has a stator core with an axial end side, a housing part that radially surrounds the stator core, and a plurality of hollow conductors, each of which passes through the stator core axially, has an outer section protruding from the stator core on the end side, and is designed to conduct a temperature control fluid in its interior; wherein the tool comprises: a base section which forms a support surface for the housing part; a centering section which protrudes from the base section and is designed to be inserted from the end side into an interior of the stator core until the support surface rests on the housing part; for each hollow conductor, a projection protruding from the base section; and a sprue opening; wherein the tool is designed, in a position in which the support surface rests on the housing part, to delimit a cavity radially on the inside by way of the centering section and axially on the outside by way of the base section and to position the projections relative to the hollow conductors in such a way that the projections form a continuation of the interior of the hollow conductors up to the base section, with the result that, when a casting compound is filled through the sprue opening, the cavity can be filled with the casting compound.

The base section is preferably of annular configuration. The support surface is preferably formed radially on the outside of the base section. The support surface extends in particular perpendicularly with respect to the axial direction. If the housing part rests on the support surface, a tolerance chain can be kept as small as possible.

The centering section is preferably formed radially on the inside of the base section. Preferably, a radially outer surface of the centering section tapers from the base section toward the interior of the stator core in order to form a draft angle.

The tool may further have a demolding section that protrudes from the base section and extends in the same direction as the centering section. The demolding section has an axial extent that decreases from radially outside to radially inside in order to facilitate removal of the tool when the cavity is filled. Preferably, the demolding section is designed to rest on the (second) housing part with its outer radius.

The projections are preferably configured so as to be tapered to a point at their free end, in particular so as to be conical or pyramid-shaped. This makes it easier to center the projections with regard to the manufacturing tolerances of the hollow conductors. Preferably, the projections are arranged in a plurality of groups that follow one another in the circumferential direction, each group comprising a plurality of projections arranged along the radial direction at a predetermined position in the circumferential direction.

The tool can further include a plurality of positioning sections, one or more of which are disposed between a respective pair of immediately adjacent groups of the projections. The positioning sections protrude from the base section in the same direction as the projections. The positioning sections can have a square, preferably trapezoidal, base area. The position sections are designed to be arranged between circumferentially adjacent hollow conductors in order to inhibit movement of the tool in the circumferential direction.

In the tool according to the invention, it is preferred if a respective projection is designed to be movable with respect to the base section and, for each projection, a restoring means arranged between the base section and the projection is provided, which is supported on the base section and is designed to exert in the position a restoring force on the projection, which acts in the direction of the hollow conductor. For this purpose, the projections can each be formed by a slide.

The restoring means can be a compression spring. The restoring means exerts the restoring force on the projection, with the result that its free end is inserted into the interior of the outer section of the hollow conductor and closes the interior while the cavity is being filled. The projection can thereby form the cooling channel for this hollow conductor in the compensation body.

The base section can be designed in two parts in the axial direction, with a first part of the base section receiving the restoring means and forming a support surface therefor. The second part of the base section can have through openings from which the projections protrude from the base section on the side facing away from the first part.

The slides are preferably designed to be thicker on their side facing the restoring means than the through openings of the second part of the base section in order to prevent them from falling out of the tool. For this purpose, the slides can strike the second part of the base section when the restoring means is fully expanded.

The object on which the invention is based is further achieved by a method for producing a stator device, in particular a stator device according to the invention, comprising the following steps: providing a stator core, which has an axial end side, and a plurality of hollow conductors, each of which axially passes through the stator core, has an outer section protruding from the stator core on the end side, and is designed to conduct a temperature control fluid in its interior; and forming a compensation body which forms a plurality of separated fluid channels, each of which connects to the outer section of one of the hollow conductors in order to guide the temperature control fluid between an opening of the fluid channel and the interior of the hollow conductor.

As part of the method according to the invention, a tool according to the invention can be brought into the position to form the compensation body, a casting compound can be filled into the cavity through the sprue opening and the casting compound can harden. The method can further comprise the following step: removing the tool. The tool is preferably locked in the position.

The method can furthermore comprise the following step: fastening a first housing part to the second housing part radially surrounding the stator core.

All statements regarding the stator device according to the invention can be transferred analogously to the tool according to the invention and the method according to the invention, with the result that the advantages described above can also be achieved with these.

The object on which the invention is based is further achieved by an electric machine, comprising a stator device according to the invention or a stator device obtained by the method according to the invention, as well as a rotor rotatably mounted in the stator core, the electric machine being configured to drive an electrically drivable vehicle. The electric machine is preferably an asynchronous machine or a, in particular permanently excited, synchronous machine.

The object on which the invention is based is also achieved by a vehicle comprising an electric machine according to the invention. The vehicle is in particular a battery-electric vehicle or a hybrid vehicle.

Further advantages and details of the present invention result from the exemplary embodiments described below and on the basis of the drawings. These drawings are schematic illustrations, in which:

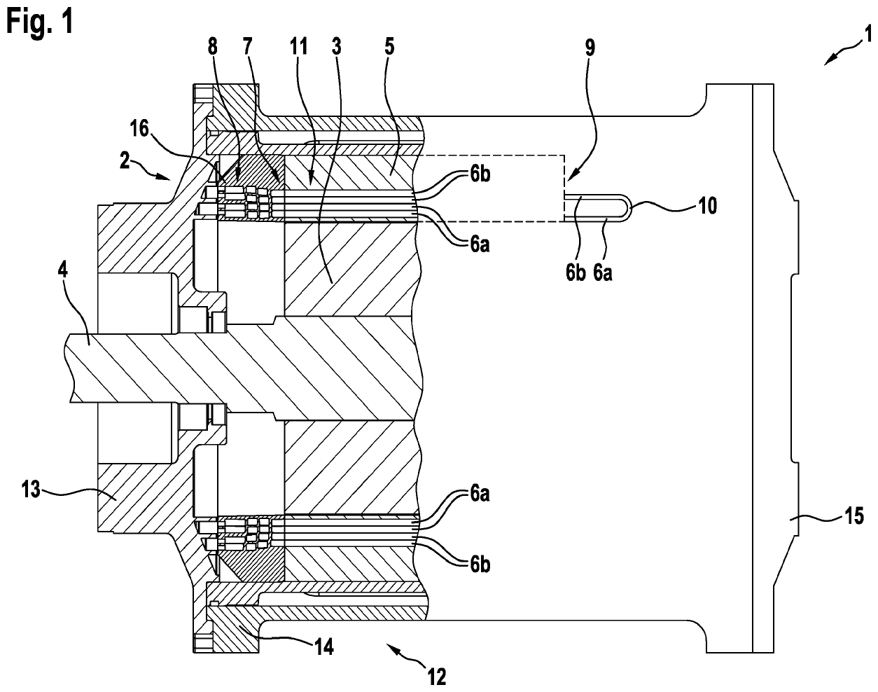

FIG. 1 shows a partially sectioned view of one exemplary embodiment of the electric machine according to the invention with an exemplary embodiment of the stator device according to the invention,

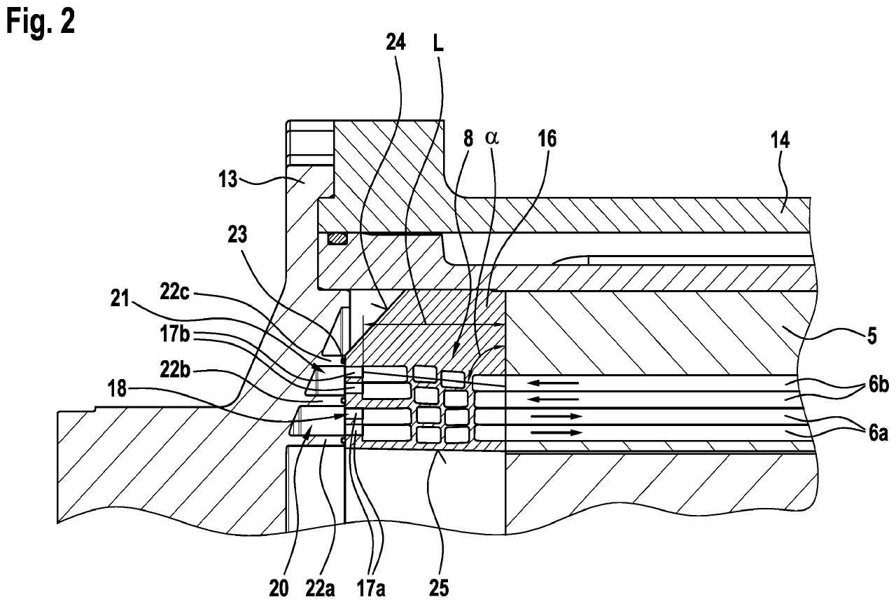

FIG. 2 shows a side detailed view of FIG. 1 in the area of the compensation body,

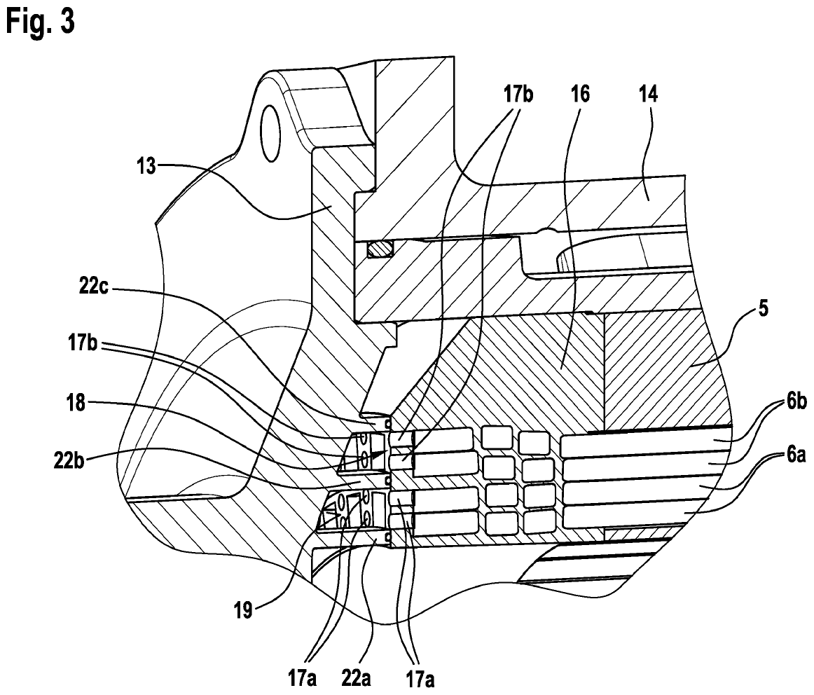

FIG. 3 shows a perspective detailed view from FIG. 1 in the area of the compensation body,

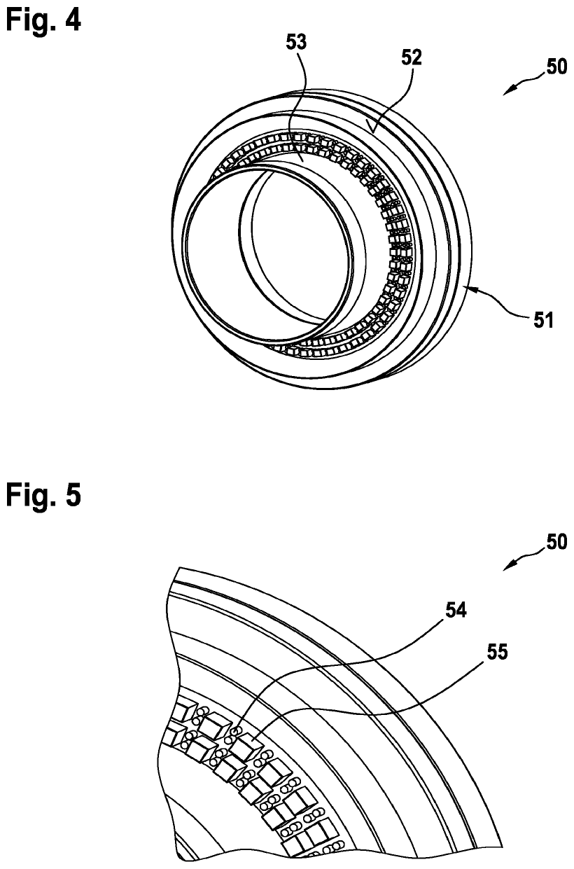

FIG. 4 shows a perspective view of one exemplary embodiment of the tool according to the invention,

FIG. 5 shows a perspective detailed view from FIG. 4,

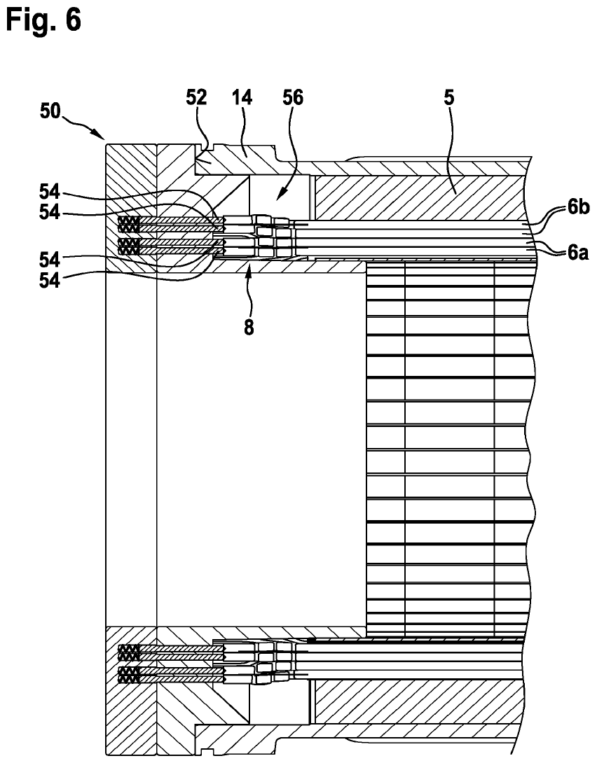

FIG. 6 shows a sectional view of the tool while carrying out one exemplary embodiment of the method according to the invention,

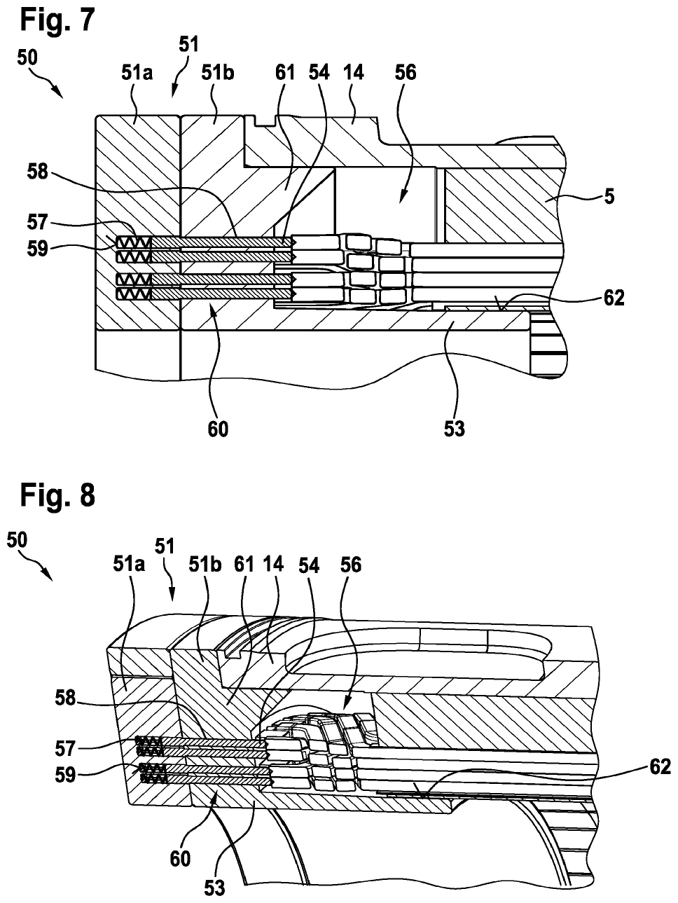

FIG. 7 shows an enlarged detailed view from FIG. 6,

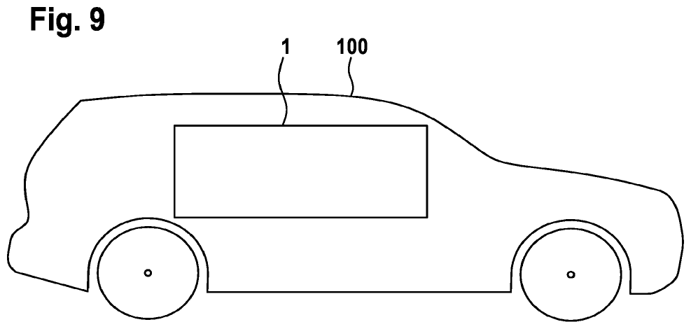

FIG. 8 shows a perspective detailed view from FIG. 6, and

FIG. 9 shows a schematic diagram of one exemplary embodiment of the vehicle according to the invention.

FIG. 1 is a partially sectioned view of one exemplary embodiment of an electric machine 1 with an exemplary embodiment of a stator device 2.

In the present initial example, the electric machine 1 is designed, for example, as a permanently excited synchronous machine and, in addition to the stator device 2, comprises a rotor 3 which is rotatably mounted with respect to the stator device and a shaft 4 which is coupled to it fixedly for conjoint rotation.

The stator device 2 comprises a stator core 5, which is designed here as an example as a stator laminated core made of a multiplicity of axially layered and mutually insulated individual laminations. A stator winding of the stator device 2 is formed from a plurality of hollow conductors 6a, 6b, each of which passes axially through the stator core 5 and has an outer section 8 protruding on an end side 7 of the stator core 5. To this end, the hollow conductors 6a, 6b are arranged in a plurality of grooves formed within the stator core 5.

The hollow conductors 6a, 6b are designed to conduct a temperature control fluid inside them. The temperature control fluid is, for example, a cooling oil. Purely as an example, the hollow conductors 6a, 6b are tubular with an internal profile that is circular in cross section. On the end side 7, the hollow conductors 6a, 6b are connected, moreover, to one another in pairs in an electrically conductive and materially bonded manner, for example by welding, in order to form a current path for the stator windings.

FIG. 1 also shows purely schematically that the hollow conductors 6a, 6b on an end side 9 of the stator core 5 opposite the end side 7 are connected to one another in pairs in a fluid-conducting manner by a connecting section 10 and thus form a U-shape. The connecting section 10 and the hollow conductors 6a, 6b connected in pairs by it are formed in one piece. The temperature control fluid can flow from the end side 7 through the outer section 8 of a hollow conductor 6a into an inner section 11 of the hollow conductor 6a arranged within the stator core 5, can flow on the end side 9 through the connecting section 10 into the hollow conductor 6b, then can flow through its inner section 11 toward the end side 7 and can leave the hollow conductor 6b there through its outer section 8.

The stator device 2 further has a housing 12. The housing 12 comprises a first housing part 13, which is designed as an A-end shield (drive end shield), a second housing part 14, which radially surrounds the stator core 5 and is designed as a housing jacket, and a third housing part 15, which is designed as a B-end shield (non-drive end shield). The first housing part 13 and the third housing part 15 are fastened to the second housing part 14. The first housing part 13 is located on the side of the end side 7 of the stator core 5. The third housing part 15 is located on the side of the opposite end side 9 of the stator core 5.

The stator device 2 is characterized by a compensation body 16, which is described in more detail below.

FIG. 2 and FIG. 3 each show a detailed view from FIG. 1 in the area of the compensation body 16, with FIG. 2 being a side detailed view and FIG. 3 being a perspective detailed view.

The compensation body 16 forms a plurality of separated fluid channels 17a, 17b, each of which connects to the outer section 8 of one of the hollow conductors 6a, 6b in order to guide the temperature control fluid between an opening 18 of the fluid channel and the interior of the hollow conductor 6a, 6b. The compensation body 16 is designed as a one-piece body with an annular basic shape made of a hardened casting compound and is arranged on the end side 7.

The compensation body 16 is integrally formed on the stator core 5 and on the second housing part 14. The compensation body 16 adjoins the stator core 5 flush radially on the inside and outside and extends in the axial direction pointing away from the stator core 5 beyond a free end of the outer section 8 of a respective hollow conductor 6a, 6b. On its side facing away from the stator core 5, the compensation body extends as far as a predetermined axial position and forms a reference surface 19 there that is perpendicular to the axial direction.

By means of the compensation body 16, manufacturing tolerances of the hollow conductors 6a, 6b with regard to their axial length L and an angle a that they enclose with the end side 7 can be compensated for by the interior of the hollow conductors 6a, 6b being widened by the fluid channels 17a, 17b which adjoin them.

The stator device 2 further comprises a first fluid chamber 20 and a second fluid chamber 21. A respective opening 18 of a first part of the fluid channels 17a opens into the first fluid chamber 20. The fluid channels 17a are connected to one another in a fluid-conducting manner by way of the first fluid chamber 20. Correspondingly, a respective opening 18 of a second part of the fluid channels 17b opens into the second fluid chamber 21, which connects the fluid channels 17b to one another in a fluid-conducting manner. The fluid chambers 20, 21 are separated from one another in a liquid-tight manner, with the first fluid chamber 20 forming a feed line of the temperature control fluid and the second fluid chamber 21 forming a return line of the temperature control fluid.

The first part of the fluid channels 17a adjoins those hollow conductors 6a which are arranged radially further inside than the hollow conductors 6b, to which the second part of the fluid channels 17b adjoins. The first fluid chamber 20 therefore lies radially within the second fluid chamber 21. In the present exemplary embodiment, the hollow conductors 6a, 6b are arranged in a radially layered manner in the grooves of the stator core 5. Four laminations are provided in each groove, with the hollow conductors 6a being accommodated in the two radially inner laminations and the hollow conductors 6b being accommodated in the two radially outer laminations. Accordingly, the fluid channels 17a are located at two radial positions that lie further inward than two radial positions at which the fluid channels 17b are located.

The fluid chambers 20, 21 are delimited axially and radially on the inside and outside by the first housing part 13. To this end, the first housing part 13 has first to third projections 22a, 22b, 22c that point axially to the stator core. The first projection 22a, which is located radially on the inside, delimits the first fluid chamber 20 radially on the inside. The second projection 22b, which is located radially in the middle, delimits the first fluid chamber 20 radially on the outside and the second fluid chamber 21 radially on the inside. The third projection 22c, which is located radially on the outside, delimits the second fluid chamber 21 radially on the outside.

A sealing means 23 in the form of an O-ring is arranged between a respective projection 22a, 22b, 22c and the compensation body in order to seal the fluid chambers 21, 22.

As can also be seen from FIG. 2 and FIG. 3, furthermore, the compensation body 16 has two draft angles 24, 25. The draft angle 24 is formed by a radially outer tapered portion of the compensation body in the direction pointing away from the stator core 5. The draft slope 25 is formed by a—substantially weaker—tapered portion of the radially inner surface of the compensation body 16 in the direction pointing toward the stator core 5. The exact function of the draft angles 24, 25 is explained in more detail below.

One exemplary embodiment of a method for producing the stator device 2 is described below. Components that are the same or have the same effect are provided with identical reference signs here.

As part of the manufacturing process, a stator core 5 with an axial end side 7, and a plurality of hollow conductors 6a, 6b, which each pass axially through the stator core 5, have an outer section 8 protruding from the stator core 5 on the end side 7 and are configured to conduct a temperature control fluid in their interior. Furthermore, a housing part 14, which radially surrounds the stator core 5 and to which the stator core 5 is fastened, is provided.

In a second step, a compensation body 16 is formed, which forms a plurality of separated fluid channels 17a, 17b, each of which connects to the outer section 8 of one of the hollow conductors 6a, 6b, in order to guide the temperature control fluid between an opening 18 of the fluid channel 17a, 17b and the interior of the hollow conductor 16a, 16b.

FIGS. 4 and 5 each show one exemplary embodiment of a tool 50 that is used as part of the manufacturing process, with FIG. 4 being a perspective view and FIG. 5 being a detailed view.

The tool 50 has a base section 51, which forms a support surface 52 for the housing part 14. Furthermore, the tool 50 has a centering section 53, which protrudes from the base section 51 and is designed to be inserted from the end side 7 into an interior of the stator core 5 until the support surface 52 rests on the housing part 14.

Moreover, the tool 50 has, for a respective hollow conductor 6a, 6b, a projection 54 which protrudes from the base section 51. The projections 54 are preferably configured so as to taper to a point at their free end, here conically. In addition, the tool 50 has a plurality of positioning sections 55, two of which are arranged in each case between a respective pair of immediately adjacent groups of projections 54. The positioning sections 55 protrude from the base section 51 in the same direction as the projections 54. The positioning sections 55 have a trapezoidal base area in order to be arranged between circumferentially adjacent hollow conductors 6a, 6b and to inhibit a movement of the tool 50 in the circumferential direction.

FIGS. 6 to 8 each show a sectioned view of the tool 50 during the implementation of the manufacturing method, with FIG. 6 being a sectioned view, FIG. 7 being an enlarged detailed view from FIG. 6, and FIG. 8 being a perspective detailed view of FIG. 6.

To form the compensation body 16, the tool 50 is brought into a position in which the support surface 52 rests on the housing part 14. The tool 50 delimits a cavity 56 radially on the inside by way of the centering section 53 and axially on the outside by way of the base section 51 and positions the projections 54 relative to the hollow conductors 6a, 6b in such a way that the projections form a continuation of the interior of the hollow conductors 6a, 6b as far as the base section 51. In the step of forming the compensation body 16, the cavity 56 is filled with a casting compound through a sprue opening (not shown) of the tool 50.

As can be seen in detail from FIG. 7, a respective projection 54 is designed to be movable with respect to the base section 54. For each projection 54 there is a restoring means 57 arranged between the base section 51 and the projection 54, which is supported on the base section 51 and is designed to exert in the position a restoring force acting in the direction of the hollow conductor 6a, 6b on the projection 54. To this end, the projections are each formed by a slide 58. The restoring means 57 is designed, for example, as a compression spring and exerts the restoring force on the projection 54 or the slide 58, with the result that its free end is inserted into the interior of the outer section 8 of the hollow conductor 6a, 6b and closes it while the cavity is being filled. The projection 54 then forms the cooling channel 17a, 17b for this hollow conductor 6a, 6b in the compensation body 16.

The base section 51 is designed in two parts in the axial direction, with a first part 51a of the base section 51 receiving the restoring means 57 and forming a support surface 59 therefor. A second part 51b of the base section 51 has through openings 60, from which the projections 54 protrude from the base section 51 on the side facing away from the first part 51a. The slides 58 are of thicker configuration on their side pointing toward the restoring means 57 than the through openings 60 of the second part 51b of the base section 51 in order to prevent them from falling out of the tool 50. To this end, the slides 58 can strike the second part 51b when the restoring means 57 is fully expanded.

The tool 50 further has a demolding section 61 which protrudes from the base section 51 and extends in the same direction as the centering section 53. The demolding section 61 rests with its outer radius on the inside of the housing part 14 and has an axial extent that decreases from radially outside to radially inside in order to facilitate removal of the tool 50 in the filled state of the cavity 56. The demolding section 61 of the tool forms the draft angle 24 (see FIG. 2) of the compensation body 16.

Furthermore, a radially outer surface 62 of the centering section 53 tapers from the base section 51 toward the interior of the stator core 5 in order to form the draft angle 25 (see FIG. 2) of the compensation body 16.

After filling the cavity 56, the casting compound hardens. In a further step of the method, the tool 50 is removed.

In a further step of the method, the first housing part 13 is fastened to the second housing part 14. The sealing means 23 can be attached.

According to further exemplary embodiments, the hollow conductors 6a, 6b have a rectangular profile and the free ends of the projections 54 are of pyramid-shaped configuration.

FIG. 9 is a schematic diagram of one exemplary embodiment of a vehicle 100.

The vehicle 100 comprises the electric machine 1, which is designed to drive the vehicle 100. The vehicle 100 is a battery-electric vehicle or a hybrid vehicle.

1. A stator device for an electric machine, comprising
a stator core which has an axial end side;
a plurality of hollow conductors which each
pass through the stator core axially,
have an outer section protruding from the stator core on the end side and
are designed to conduct a temperature control fluid in their interior; and
a compensation body, which forms a plurality of separated fluid channels, each of which connects to the outer section of one of the hollow conductors in order to conduct the temperature control fluid between an opening of the fluid channel and the interior of the hollow conductor.

2. The stator device as claimed in claim 1, wherein
the compensation body is integrally formed on the stator core.

3. The stator device as claimed in claim 1, wherein
the compensation body adjoins the stator core flush radially on the inside and/or outside of the stator core.

4. The stator device as claimed in claim 1, wherein
the compensation body extends in the axial direction pointing away from the stator core beyond a free end of the outer section of a respective hollow conductor.

5. The stator device as claimed in claim 1, furthermore comprising
a fluid chamber, into which a respective opening of at least part of the fluid channels opens and which connects the openings of the fluid channels to one another in a fluid-conducting manner.

6. The stator device as claimed in claim 5, further comprising
a housing part, in particular an end shield, which forms an axial boundary, a radially inner boundary and a radially outer boundary of the fluid chamber and rests on the compensation body.

7. The stator device as claimed in claim 5, further comprising
a second fluid chamber, into which a respective opening of a second part of the fluid channels opens, which connects the openings of the second part of the fluid channels to one another in a fluid-conducting manner and which, on the end side, is separated from the first fluid chamber in at least a liquid-tight manner.

8. The stator device as claimed in claim 6, wherein
the housing part forms an axial boundary, a radially inner boundary and a radially outer boundary of the second fluid chamber.

9. The stator device as claimed in claim 6, further comprising
a second housing part, which radially surrounds the stator core and to which the first housing part is fastened, the compensation body being integrally formed on the second housing part.

10. A tool for forming a compensation body of a stator device, which has a stator core with an axial end side, a housing part which radially surrounds the stator core, and a plurality of hollow conductors, which each pass axially through the stator core, have an outer section protruding from the stator core on the end side and are designed to conduct a temperature control fluid in their interior; wherein the tool has:
a base section which forms a support surface for the housing part;
a centering section, which protrudes from the base section and is designed to be inserted from the end side into an interior of the stator core until the support surface rests on the housing part;
for a respective hollow conductor, a projection which protrudes from the base section; and
a sprue opening;
wherein the tool is designed to delimit a cavity radially on the inside by way of the centering section and axially on the outside by way of the base section in a position in which the support surface rests on the housing part and to position the projections relative to the hollow conductors in such a way that the projections form a continuation of the interior of the hollow conductors as far as the base section, with the result that, when filling a casting compound through the sprue opening, the cavity can be filled with the casting compound.

11. The tool as claimed in claim 10, wherein
a respective projection is designed to be movable with respect to the base section and, for each projection, a restoring means arranged between the base section and the projection is provided, which is supported on the base section and is designed to exert in the position a restoring force on the projection, which acts in the direction of the hollow conductor.

12. A method for producing a stator device, in particular as claimed in claim 1, comprising the following steps:
providing a stator core, which has an axial end side, and a plurality of hollow conductors, each of which axially passes through the stator core, has an outer section protruding from the stator core on the end side, and is designed to conduct a temperature control fluid in its interior; and
forming a compensation body, which forms a plurality of separated fluid channels, each of which connects to the outer section of one of the hollow conductors in order to guide the temperature control fluid between an opening of the fluid channel and the interior of the hollow conductor.

13. The method as claimed in claim 12, further comprising providing a tool for forming a compensation body of a stator device, which has a stator core with an axial end side, a housing part which radially surrounds the stator core, and a plurality of hollow conductors, which each pass axially through the stator core, have an outer section protruding from the stator core on the end side and are designed to conduct a temperature control fluid in their interior; wherein the tool has:
a base section which forms a support surface for the housing part;
a centering section, which protrudes from the base section and is designed to be inserted from the end side into an interior of the stator core until the support surface rests on the housing part;
for a respective hollow conductor, a projection which protrudes from the base section; and
a sprue opening;
wherein the tool is designed to delimit a cavity radially on the inside by way of the centering section and axially on the outside by way of the base section in a position in which the support surface rests on the housing part and to position the projections relative to the hollow conductors in such a way that the projections form a continuation of the interior of the hollow conductors as far as the base section, with the result that, when filling a casting compound through the sprue opening, the cavity can be filled with the casting compound, and
wherein, to form the compensation body, a the tool is brought into the position, a casting compound is filled into the cavity through the sprue opening and the casting compound hardens, the method further comprising the following step: removing the tool.

14. An electric machine, comprising a stator device as claimed in claim 1, and a rotor rotatably mounted in the stator core, wherein the electric machine is designed to drive an electrically drivable vehicle.

15. A vehicle, comprising an electric machine as claimed in claim 14.

16. The stator device as claimed in claim 2, wherein
the compensation body adjoins the stator core flush radially on the inside and/or outside of the stator core.

17. The stator device as claimed in claim 2, wherein
the compensation body extends in the axial direction pointing away from the stator core beyond a free end of the outer section of a respective hollow conductor.

18. The stator device as claimed in claim 2, furthermore comprising
a fluid chamber, into which a respective opening of at least part of the fluid channels opens and which connects the openings of the fluid channels to one another in a fluid-conducting manner.

19. The stator device as claimed in claim 6, further comprising
a second fluid chamber, into which a respective opening of a second part of the fluid channels opens, which connects the openings of the second part of the fluid channels to one another in a fluid-conducting manner and which, on the end side, is separated from the first fluid chamber in at least a liquid-tight manner.

20. The stator device as claimed in claim 7, wherein
the housing part forms an axial boundary, a radially inner boundary and a radially outer boundary of the second fluid chamber.
